(19) United States
(12) Patent Application Publication
(10) Pub. No.: US 2013/0085765 A1
(43) Pub. Date: Apr. 4, 2013

(54) SYSTEM AND METHOD FOR PROVIDING CUSTOMIZED ALERT SETTINGS

(71) Applicants: Charles Tuchinda, Los Altos, CA (US); Virginia Lorraine Halsey, San Francisco, CA (US)

(72) Inventors: Charles Tuchinda, Los Altos, CA (US); Virginia Lorraine Halsey, San Francisco, CA (US)

(21) Appl. No.: 13/249,842

(22) Filed: Sep. 30, 2011

(51) Int. Cl. G06Q 50/22

(52) U.S. Cl. 705/2

(57) ABSTRACT

A system and method for providing customized alert settings operating on at least one computer device. The system and method including receiving, from a server, starting drug interaction content via a network, providing, from a server, a drug interaction alert customization request based on the initial drug interaction content via a network, receiving, a customized data base file comprising the customized drug interaction alert settings via the network, wherein the customized drug interaction alert settings are automatically implemented in a prescribing software executing on the one or more end user-systems.

### FIELD OF THE INVENTION

The present invention relates to a system and method for generating customized alert settings.

### BACKGROUND

In the healthcare industry, various alert systems exist to notify healthcare providers of potential hazards that may arise when providing patient treatment. Exemplary alerts include drug-drug interaction alerts, dosage alerts, drug-allergy alerts, duplicate therapy alerts, duplicate medication alerts, pregnancy precautions alerts, lactation precaution alerts, and drug-food alerts. The vast number of alerts that may be triggered during routine healthcare procedures can be overwhelming, and there is a tendency among healthcare professionals to disregard or “tune-out” alerts because of the high percentage of false or irrelevant alerts.

### SUMMARY OF THE INVENTION

Patient treatment procedures vary tremendously from patient to patient and from healthcare provider to healthcare provider. For instance, treatments that may be considered appropriate and effective at a cancer treatment facility may be potentially lethal at a pediatric clinic. Despite the vast difference between appropriate treatments at these facilities, healthcare alerts settings may be standardized across the healthcare industry. So, for example, the drug-drug interaction databases relied-upon at a cancer treatment facility may have the same settings as the drug-drug interaction database relied-upon at a pediatric facility. The standardization of alerts can lead to “alert fatigue,” where healthcare providers tend to tune out alerts because they are inundated with inconsequential alerts and cannot determine which alerts warrant closer consideration. Accordingly, there is a need for an improved system for reducing the number of unnecessary or irrelevant alerts to ensure that only the most meaningful alerts are presented to healthcare professionals. It is therefore useful to have a system and method for providing customized alert settings.

At least one exemplary embodiment includes a system for providing customized drug interaction alert settings to one or more end-user systems at a health care institution. This embodiment may include a user interface to provide initial drug interaction and to receive customized drug interaction alert settings based on the initial drug interaction content. Customized databases may be configured to provide customized drug interaction settings which may be automatically implemented in a prescribing software program executing on one or more end-user systems.

Other embodiments may also provide a method of generating one or more customized drug interacting alert settings associated with a health care institution. This embodiment may include receiving drug interaction content via a network, allowing a user to generate one or more customized drug interaction alert settings based on the initial drug interaction content by performing a drug interaction alert modification action, and providing the one or more drug interaction alert settings via the network.

Additional embodiments may include a method of elimination one or more drug interaction alerts on an end-user system of a health care institution. This exemplary embodiment may include receiving one or more drug interaction alert settings, receiving an order for a new drug associated with a patient, comparing the order for the new drug to a plurality of drugs associated with the patient, and initiating one or more drug interaction alerts based on the comparison and the one or more customized drug interaction alert settings.

### BRIEF DESCRIPTION OF THE DRAWINGS

The foregoing and other aspects and advantages will be better understood from the following detailed description of the invention with reference to the drawings, in which:

FIG. 1 is an exemplary bar chart depicting the distribution of exemplary alert events in a healthcare provider environment;

FIG. 2 illustrates a block diagram of a system for providing customized alert settings, in accordance with exemplary embodiments;

FIG. 3 illustrates exemplary modules of a customized alert generation system, a user system, and a drug database system, in accordance with exemplary embodiments;

FIG. 4 illustrates an exemplary screen shot of a starting database screen, in accordance with exemplary embodiments;

FIG. 5 illustrates an exemplary screen shot of a drug-drug interaction search screen, in accordance with exemplary embodiments;

FIG. 6 illustrates an exemplary screen shot of a community-polling screen, in accordance with exemplary embodiments;

FIG. 7 illustrates an exemplary screen shot of alerts sorted by severity level, in accordance with exemplary embodiments;

FIG. 8 illustrates an exemplary screen shot of exemplary drug-drug interaction categories, in accordance with exemplary embodiments;

FIG. 9 illustrates an exemplary screen shot of a drug-drug interaction dashboard, in accordance with exemplary embodiments;

FIG. 10 illustrates an exemplary screen shot of a drug-drug interaction list based on keyword searches, in accordance with exemplary embodiments;

FIG. 11 illustrates an exemplary screen shot of a drug-drug interaction alert customization interface, in accordance with exemplary embodiments;

FIG. 12 illustrates an exemplary screen shot of a commenting interface, in accordance with exemplary embodiments;

FIG. 13 illustrates an exemplary screenshot of a drug-drug interaction customization interface, in accordance with exemplary embodiments;

FIG. 14 illustrates an exemplary screenshot of an additional drug-drug interaction customization interface, in accordance with exemplary embodiments;

FIG. 15 illustrates an exemplary screenshot of an additional drug-drug interaction customization interface, in accordance with exemplary embodiments;

FIG. 16 illustrates an exemplary screenshot of a database export interface, in accordance with exemplary embodiments;

FIG. 17 is a flow chart illustrating a method for providing customized alert settings, in accordance with exemplary embodiments;

FIG. 18 illustrates an exemplary screen shot of an alert display screen, in accordance with exemplary embodiments; and

FIG. 19 illustrates an exemplary screen shot of an audit trail screen, in accordance with exemplary embodiments.

### DETAILED DESCRIPTION OF EMBODIMENTS OF THE INVENTION

In an exemplary embodiment, a system for providing customized alert settings may be utilized to generate one or more customized alert databases (e.g., drug-drug interaction alerts, dose alerts, drug-allergy interaction alerts, duplicate therapy alerts, duplicate medication order alerts, pregnancy precaution alerts, lactation precaution alerts, drug-food interaction alerts, TPN (“Total Parenteral Nutrition”) alerts, etc.) to be utilized in a healthcare provider setting. For example, a user (e.g., healthcare provider, administrator, etc.) may interact with the system to search for and/or select a starting alert database (e.g., First DataBank drug-drug interaction database, available from First DataBank, Inc. of San Francisco, Calif.). Users may also interact with the system to search for and/or select an overlay database, which may provide a list of preferred drug-drug interaction alert settings. For example, the overlay database may be a PQA Alliance drug-drug interaction database, available from Pharmacy Quality Alliance (PQA, Inc.) of Fairfax Station, Va. It should be appreciated that the present system is not limited to drug-drug interaction alerts only, and that it is not limited to the use of both an unaltered drug-drug interaction database and an overlay database. In various exemplary embodiments, any sort of existing alert database may be modified in accordance with the exemplary customized alert system. A user may interact with the system for providing customized alert settings by inputting data associated with particular alert preferences, such as to modify the starting database, which will trigger the circumstances required for an alert to be triggered in a health-care provider environment. The inputted data may be processed by the customized alert generation system to process and generate a customized alert database.

The customized alert generation system may offer a number of customization options. For example, a customized alert generation system may permit the user to modify the alert-trigger settings for a particular drug-drug interaction. In various embodiments, this may involve modifying the severity level (e.g., contraindicated drug combination, severe interaction, moderate interaction, alternate therapy interaction, etc.) of a given drug-drug interaction. Additional exemplary embodiments may provide the user with the option to change the membership class for the drug-drug interaction or remove particular interactions from portions of the database. (e.g., Ability to move interactions to or from particular categories or sub-categories. For instance, a particular drug may be a sulfa-drug, but for purposes of a given database, it may not be considered a sulfa-drug). In other exemplary embodiments, the customized alert generation system may prompt a user to provide comments related to an alert level for a particular interaction. Inputted comments may eventually be presented to other end-users (or any other third-parties) to provide additional information. For example, the inputted comments may provide insight into the reasons for the end-user's decision to modify the alert settings for a particular drug-drug interaction. Based on the inputted data, the alert customization system may modify the alert settings for one or more particular alerts (e.g., drug-drug interaction alerts, duplicate therapy alerts, etc.).

According to exemplary embodiments, various levels of alert customization may be offered to provide the user with significant control over the configuration of a given alert database. Therefore, by providing customized and more narrowly-tailored alert settings for particular healthcare environments, the system and method described in the present invention operate to reduce the overall number of alerts, while increasing the effectiveness of the alerts that are presented to a healthcare provider.

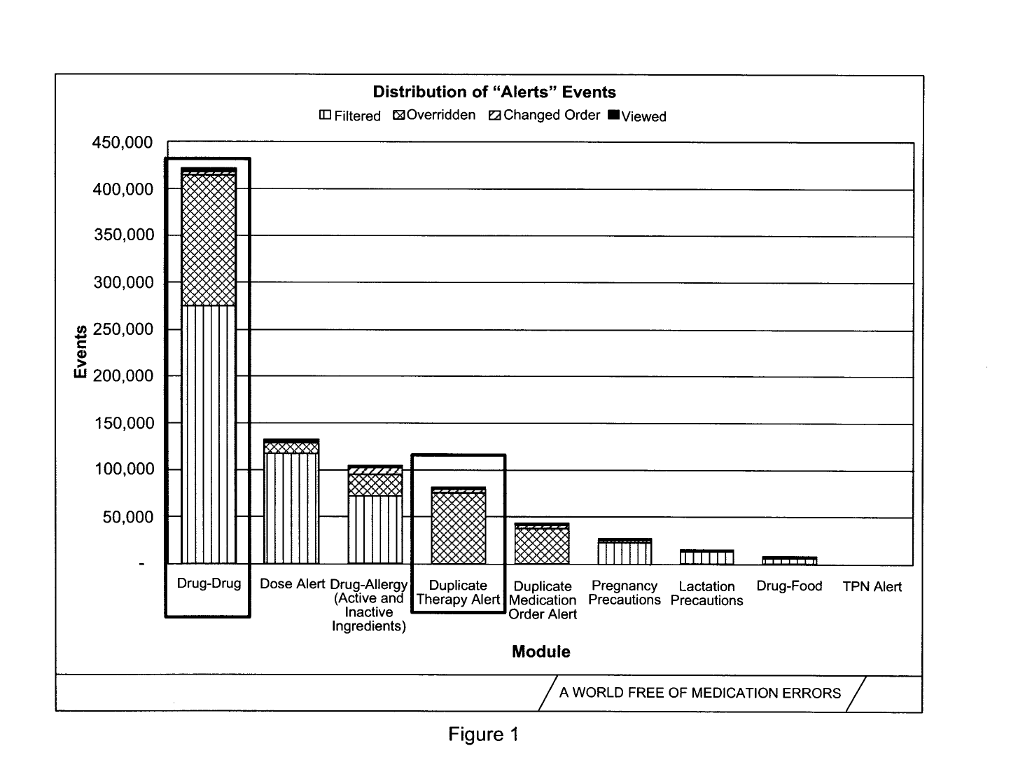

FIG. 1 illustrates an exemplary bar chart depicting the distribution of exemplary alert events in a healthcare provider environment. For example, alerts relating to various aspect of treatment (drug-drug interaction alerts, dosage alerts, drug-allergy alerts, duplicate therapy alerts, duplicate medication alerts, pregnancy precautions alerts, lactation precaution alerts, and drug-food alerts, TPN alerts, etc.) may be, for example, filtered, overridden, changed order, or viewed. For example, a starting database (e.g., First Databank drug-drug interaction database) may provide beginning alert settings for certain drug-drug interactions. Each drug-drug interaction may be provided an initial “weight” which will determine whether the interaction alert is displayed to a user. For example, the starting database may indicate that any drug-drug interaction weighted below a certain benchmark will not be presented to a user, while presenting drug-drug interactions with a higher weighting to be presented to the user. Those alerts that are triggered, but not presented to a user, may be considered to be “filtered” alerts.

Other alert events may relate to “overridden” alerts. Overridden alerts may be alerts that, based on the weight provided in the starting database, are presented to a health-care provider administering treatment. Despite being presented with the alert, the health-care provider may “override” the alert and continue with the treatment. As shown in FIG. 1, the number of “filtered” and “overridden” alerts can be quite high.

“Change order” alert events, may relate to alerts that, based on the weight provided in the starting database, are presented to a healthcare provider administering treatment. In the “change order” alert event, the healthcare provider changes the treatment provided, presumably in response to the presented alert. As shown in FIG. 1, there tend to be much fewer “change order” alert events relative to “filtered” or “overridden” alert events. Accordingly, it would be beneficial to provide a tool to customize a starting alert database, in order to tailor triggered alerts and reduce the number of “overridden” alerts and increase the number of “changed order” alerts.

A viewed alert event may relate to an alert that has been displayed, but there is no option for the user to respond. Therefore, there may be no way of knowing whether the healthcare provider changed their action as a result of the alert.

As shown in FIG. 1, the number of filtered or overridden alerts may vastly outnumber alert events that result in a changed treatment provided by the healthcare provider. The high frequency of overridden alerts, relative to these changed order alert events, may cause healthcare providers to tune out all alerts and not appreciate the significance of the few number of “valid” alerts that may be presented based on the prospective treatment plan. To alleviate this problem, exemplary embodiments provide for systems and methods for providing customized alert settings to better tailor alerts for particular treatment options and healthcare providers.

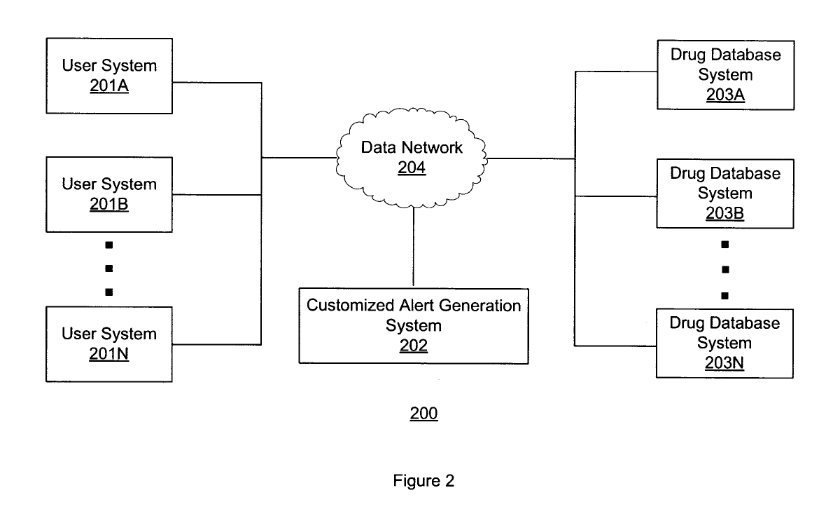

FIG. 2 illustrates a block diagram of a system 200 for providing customized alert settings, in accordance with exemplary embodiments. The system 200 may include one or more user systems 201, a customized alert generation system 202, one or more drug database systems 203, and/or a data network 204.

The one or more user systems 201 may be in communication with the data network 204. The data network 204 may include one or more of a local area network (LAN), a wide area network (WAN), the Internet, cellular networks, satellite networks, passive optical networks, or other networks that permit the transfer and/or reception of data. The data network 204 may utilize one or more protocols of network clients. The data network 204 may also translate to or from other protocols to one or more protocols of network clients. In exemplary embodiments, the data network 204 may include one or more of the exemplary networks recited above operating as a stand-alone network or in cooperation with each other. Use of the term “network” herein is not intended to limit the network to a single network.

The one or more user systems 201, the customized alert generation system 202, and/or the one or more drug database systems 203 may be in communication with or have access to one or more data networks 204. For example, one or more user systems 201, customized alert generation system 202, and/or drug database system 203 may communicate with each other using one or more data networks 204.

A user, such as a healthcare provider, administrator, doctor, nurse, or assistant, may interact with the customized alert generation system 202 and/or the one or more drug database systems 203 using the one or more user systems 201. The one or more user systems 201, the customized alert generation system 202, and/or the one or more drug database systems 203 may include, but are not limited to, a computer device or communications device including, e.g., a personal computer (PC), a workstation, a mobile device, a phone, a handheld PC, a personal digital assistant (PDA), a thin system, a fat system, network appliance, an Internet browser, a paging device, an alert device, a television, an interactive television, a receiver, a tuner, a high definition (HD) television, a video-on-demand (VOD) system, a server, a lap top, and/or any other device that is configured to communicate and/or receive data.

One or more user systems 201 may include any device that is configured to generate and/or transmit customized alert data signals (e.g., customized alert data), drug database retrieval data signals (e.g., drug database retrieval data), and/or user identification data signals (e.g., user identification data) to the data network 204 and/or receive one or more request signals for user input from the data network 204.

Drug database system 203 may include any device that is configured to store, host and/or maintain drug database data and/or transmit drug database data signals (e.g., drug database data) to the data network 204 and/or receive one or more request signals for drug database data from the data network 204. The drug database system 203 may include published alert databases (e.g., First DataBank drug-drug interaction database, First Databank duplicate therapy database, etc.) or overlay database (e.g., PQA Alliance drug-drug interaction database) which may be updated by database users.

Customized alert generation system 202 may include any device that is configured to receive and/or process customized alert data signals, drug database retrieval data signals, user identification data signals, from the data network 204 and/or generate and/or transmit one or more request signals for user input, one or more customized alert generation signals, and/or one or more drug database data signals to the data network 204. Customized alert generation system 202 may by configured to provide access to one or more drug database systems 203 and/or one or more user systems 201 The user system 201, the customized alert generation system 202, the drug database system 203, and/or the data network 204 are discussed in further detail below.

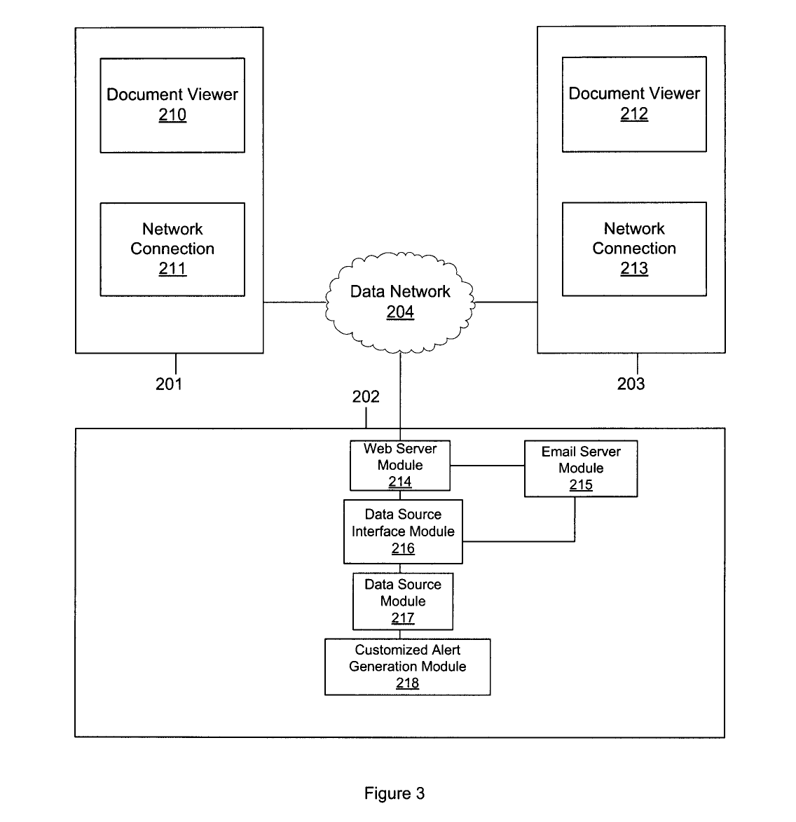

FIG. 3 illustrates exemplary modules of a user system 201, a customized alert generation system 202, and a drug database system 203, in accordance with exemplary embodiments. As illustrated in FIG. 3, the user system 201 may include a document viewer module 210 (which enables the user to access and/or generate data) and/or a network connection module 211 (which enables the user system 211 to access the data network 204 and/or the customized alert generation system 202). In various embodiment, a user that interacts with the user system 201 may include one or more health care providers, health care administrators, doctors, nurses, assistants, etc.

As illustrated in FIG. 3, the drug database system 203 may include a document viewer module 212 (which enables a user to access and/or generate data) and/or a network connection module 213 (which enables the drug database system 203 to access the data network 204 and/or the customized alert generation system 202). In various embodiments, a user that interacts with the drug database system 203 may include one or more drug database providers, such as First DataBank or PQA Alliance, which publish alert databases (e.g., drug-drug interaction databases, drug-allergy interaction databases) or overlay databases. It should be appreciated that any number of users may interact with the drug database system 203 and that any sort of drug database, whether altered or unaltered, may be utilized in connection with the present invention.

To input and extract data from customized alert generation system 202, an electronic document (e.g., a Web page) may be loaded in a conventional manner into the document viewer 210 and/or the document viewer 212. The document viewer 210 and/or the document viewer 212 may include any software application capable of viewing electronic document and/or loading additional electronic documents associated with the original electronic document, such as through the use of a hypertext link (although not limited thereto).

For example, the document viewer 210 and/or the document viewer 212 may include a Web Browser, such as Apple's Safari browser or Microsoft's Internet Explorer browser. Other interfaces may also be used, including Microsoft Excel, Access, any many other software programs. One or more electronic documents may be loaded automatically when the document viewer 210 and/or the document viewer 212 are activated and/or may be opened into a viewer window by a user (e.g., a health care provider, a drug database system user) from a file stored locally or remotely. For example, a user may load one or more electronic documents by inputting the web address of the one or more electronic documents into the web browser's command line.

The document viewer 210 and/or the document viewer 212 may be accessed by a user through the user system 201 and/or the drug database system 203, respectively. The document viewer 210 and/or the document viewer 212 may be connected to the Internet through the network connection 211 and/or the network connection 212, respectively. The network connection 211 and/or the network connection 213 may obtain access to one or more networks using one or more local telephone likes, one or more integrated services digital network (IDSN) connections, one or more digital subscriber line (DSL) connections, one or more direct network connections (e.g., Ethernet network connection), and/or one or more leased line connections. The network connection 211 and/or the network connection 213 may include a computer network that routes any data from the document viewer 210 and/or the document viewer 212 to the appropriate location on the Internet. It should be noted that this operation is well known to those of skill in the art. The network connection 211 and/or the network connection 213 may be configured to connect the document viewer 210 and/or the document viewer 212 to the web sever module 214 of the customized alert generation system 202 through one or more well-known connection schemes, such as through the use of leased lines, respectively.

A user and/or a user system 201 may communicate with an/or interact with a user and/or the customized alert generation system 202 via the data network 204 and/or a drug database system 203. The customized alert generation system 202 may include one or more web server modules 214, one or more email server modules 215, one or more data source interface module 216, one or more data source modules 217, and/or one or more customized alert generation modules 218.

The web server module 214 may include software and/or hardware configured to transmit and/or process one or more data requests from the document viewer 210 and/or the document viewer 212. For example, web server module 214 may include one or more applications, such as the Apache Web server application, etc. The web server module 214 may transmit an electronic document request and/or a data request from the document viewer 210 and/or the document viewer 212 to data source interface module 216. Data source interface module 216 may access data source module 217. In other exemplary embodiments, data may be transmitted throughout the various components of the system via File-Transfer Protocol (“FTP”) or via uploading and downloading data to a disc (e.g., Compact-Disc Read-Only Memory (“CD-ROM”)).

Data source interface module 216 may include software or hardware configured to access data stored in the data source module 217 and/or accessible by the data source module 217. Data source module 217 may store and/or access data provided by one or more users interacting with user system 201 and/or one or more users interacting with drug database system 203. Data source module 217 may also store and/or access data generated by the one or more modules of the customized alert generation system 202.

After an electronic document is loaded into the document viewer 210 and/or the document viewer 212, a user interacting with the user system 201 and/or a user interacting with the drug database system 203 may input the appropriate data. In various embodiment, a user interacting with user system 201 and/or a user interacting with a drug database system 203 may activate the transmission of the inputted data to the customized alert generation system 202 by activating a virtual button (e.g., a “Submit” button). In various embodiment, the activation of the transmission of the inputted data may include a hypertext transfer protocol (HTTP) request or a FTP request transmitted over the Internet using TCP/IP and/or a Secure Socket Layer (SSL). In an exemplary embodiment, the request may be routed through the network connection 211 or the network connection 213, the web server module 214, to the data source interface module 216. It should be noted that the details of HTTP operation in conjunction with TCP/IP and SSL are well known to those of ordinary skill in the art.

When a request (e.g., HTTP request) is received, the data source interface module 216 may access the data source module 217 to retrieve the requested data based upon the request signal from the document viewer 210 or the document viewer 212, store data received from the document viewer 210 or the document viewer 212, perform calculations using the received data and/or any combination of these functions. In an exemplary embodiment, a common gateway interface (CGI) program that is well known to those of ordinary skill in the art, may be used to parse the data from the document viewer 210 or the document viewer 212. Exemplary CGI interfaces may include ColdFusion, available from Adobe Systems Inc. of San Jose, Calif. The CGI program may operate as an interface between the web server module 214, the data source interface module 216, and/or the data source module 217 by executing one or more instructions. It should be noted that the interaction of web servers and CGI programs and the transmission of data there between is well know to those of ordinary skill in the art.

The CGI program may extract the data associated with an electronic document of the web server module 214 and retrieve the appropriate data from the data source module 217. it should be noted that this may be accomplished in one or more ways known to those of ordinary skill in the art. For example, the CGI program may include a database access module associated with one or more commercially available relational database applications (e.g., Oracle, Sybase, SQL Server).

One or more data signals may be transmitted to or received from the data source module 217 based on the data signal transmitted by the document viewer 210 or the document viewer 212. The data source interface module 216 may then generate and/or transmit one or more data signals to the document viewer 210 or the document viewer 212 in response to one or more data requests via web server module 214. In various embodiment, the email server module 215 may include software and/or hardware configured to communicate with a user interacting with a user system 201 and/or a user interacting with the drug database system 203 using a known transmission protocol, such as simple mail transfer protocol (SMTP) and/or by outputting the data signals to one or more web sites that may further process the one or more data signals.

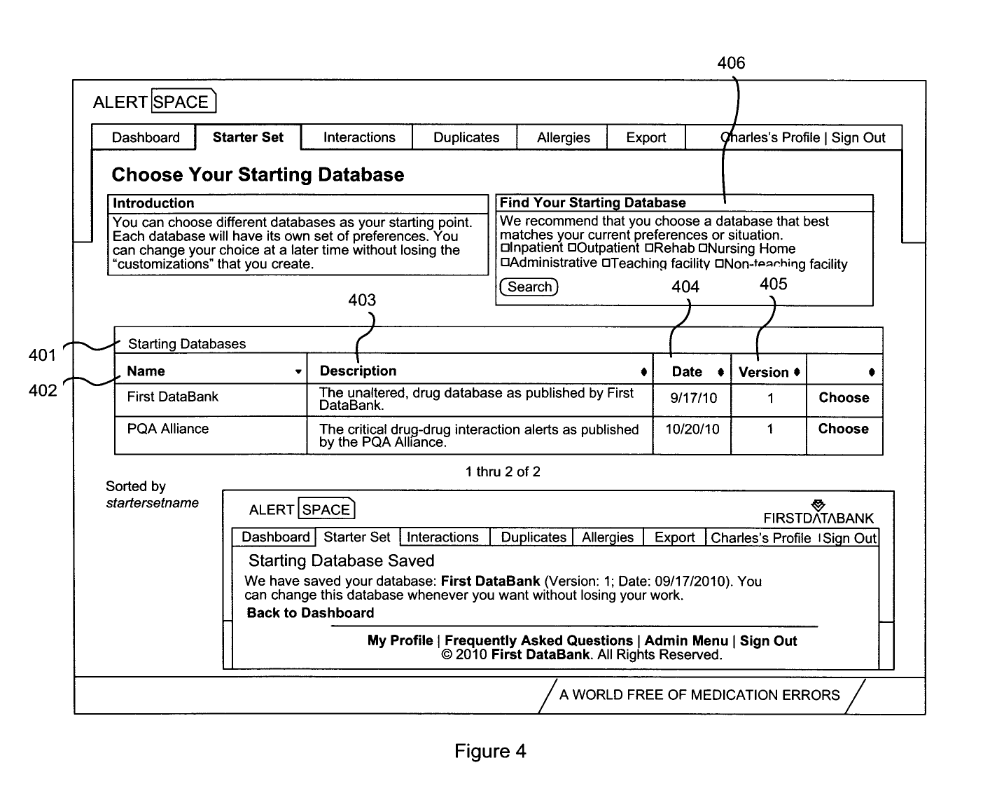

The data source module 217 may include software and/or hardware configured to transmit data to, access data in, and/or receive data from a customized alert generation module 218. The customized alert generation module 218 may be configured to access a given database from drug database system 203 and/or present a database to a user operating on user system 201. The customized alert generation module 218 may also be configured to facilitate various user functions received from a user operating on user system 201. For example, the customized alert generation module 218 may provide aspects of a database to one or more user systems 201 based upon user search requests or virtual button inputs. The customized alert generation module 218 may further modify a given database in accordance with various user inputs. The capabilities of the various modules of the present invention will be described in more detail below with regard to the exemplary embodiments described with regard to FIGS. 4-17. While FIGS. 4-17 depict drug-drug interaction alerts, it should be appreciated that these figures are exemplary only and that any type of alert customization may be utilized according to the various embodiments of the invention. For example, dose alerts, drug-allergy interaction alerts, duplicate therapy alerts, duplicate medication order alerts, pregnancy precaution alerts, lactation precaution alerts, drug-food interaction alerts, and/or TPN (“Total Parenteral Nutrition”) alerts may also be affected according to the various embodiments of the present invention.

FIG. 4 illustrates an exemplary screen shot of a starting database screen, in accordance with exemplary embodiments. As depicted in FIG. 4, a user interacting with a user system 201 may be provided with a starting database list 401. The starting database list 401 may include one or more starting databases, such as a First DataBank drug-drug interaction database. Further, the starting database list 401 may also include one or more overlay databases, such as a PQA Alliance critical drug-drug interaction database. The starting database list 401 may provide a starting database name field 402, a starting database description field 403, a starting database date field 404, and/or a starting database version field 405. A user interacting with a user system 201 may also be presented with a search function 406 to assist the user in locating the appropriate starting database or overlay database. In an exemplary embodiment, the search function 406 may include fields for selecting the particular treatment setting for which a starting database is needed. For example, a user may search for a particular database by selecting the inpatient, outpatient, rehab, nursing home, administrative, teaching facility and/or non-teaching facility fields within the search function 406.

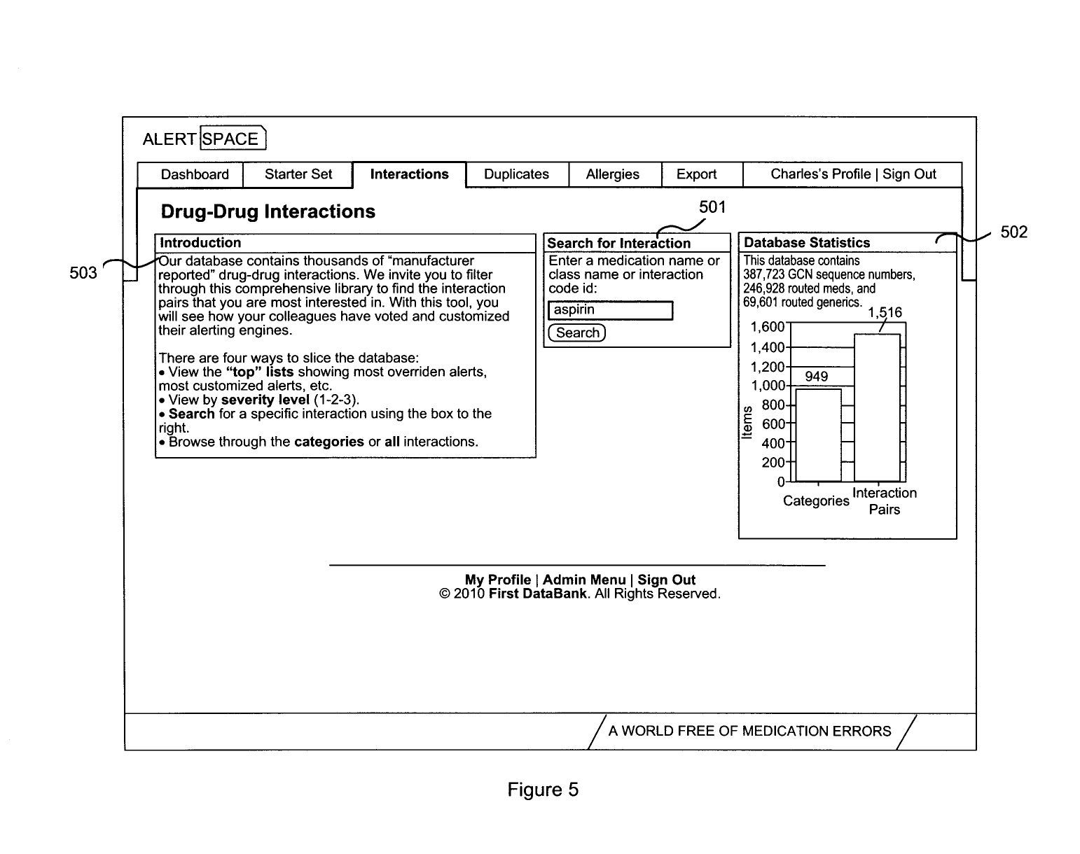

FIG. 5 illustrates an exemplary screen shot of a drug-drug interaction search screen, in accordance with exemplary embodiments. As illustrated in FIG. 5, a user interacting with a user system 201 may be provided an interaction search field 501 to search for interactions. For example, an end-user may search for interactions related to the medication “Aspirin.” Search terms may include, by way of non-limiting example, particular medication name and/or a particular class name and/or a particular code ID. It should be appreciated that various methods, including auto-complete and spell-correction may be utilized in connection with the search feature. In other exemplary embodiments, the search-function may utilize voice-recognition technology (e.g., Soundex). In various embodiments, database statistics 502 may be provided to provide an end-user with a graphical or numeric indication of certain statistics related to database items. For example, database statics 502 may include the number of categories or interaction pairs related to a particular interaction. In additional exemplary embodiments, introduction information 503 may be provided to provide instructions for interacting with the system. For example, users may be instructed to search for particular drug-drug interaction pairs and filter through pairs according to popularity level (e.g., most overridden alerts, most customized alerts, etc.), severity level, specific interactions, or by browsing through particular categories or interaction pairs. In various exemplary embodiments, the user may be presented with alerts recommended to be modified. For example, the user may be presented with alerts recommended to be modified based on alerts that are most fired, most overridden, and/or most ignored. In additional various embodiments, the alert recommendation process may occur iteratively such that the user may modify certain recommended alerts, which may then be published to a customized database, then the user may subsequently be provided with additional recommended alerts to be modified.

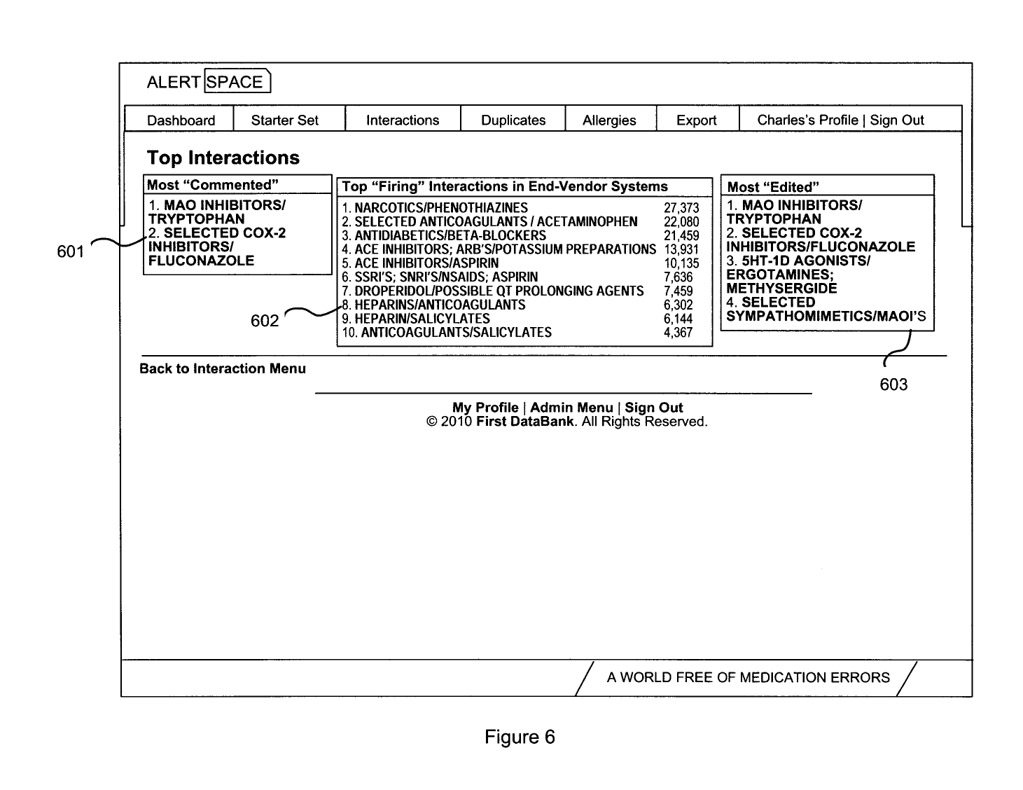

FIG. 6 illustrates an exemplary screen shot of a community-polling screen, in accordance with exemplary embodiments. As depicted in FIG. 6, a user interacting with a user system 201 may be presented with “community polling” data. Such data may be obtained from a customized alert generation system, such as customized alert generation system 202. The customized alert generation system may compile data from each of the user systems 201A-201N to compile and process alert data. For instance, an end-user may be presented with community polling data related to most commented interactions 601, most displayed interactions 602, or most edited interactions 603. This exemplary community-polling feature may provide an end-user with real-time or near real-time information related to alerts throughout all end-user systems. In exemplary embodiments, the interactions listed in fields 601, 602, and/or 603 may be selectable, whereby particular interactions may be selected and the user may be presented with an interface for customizing the alert setting for that particular alert.

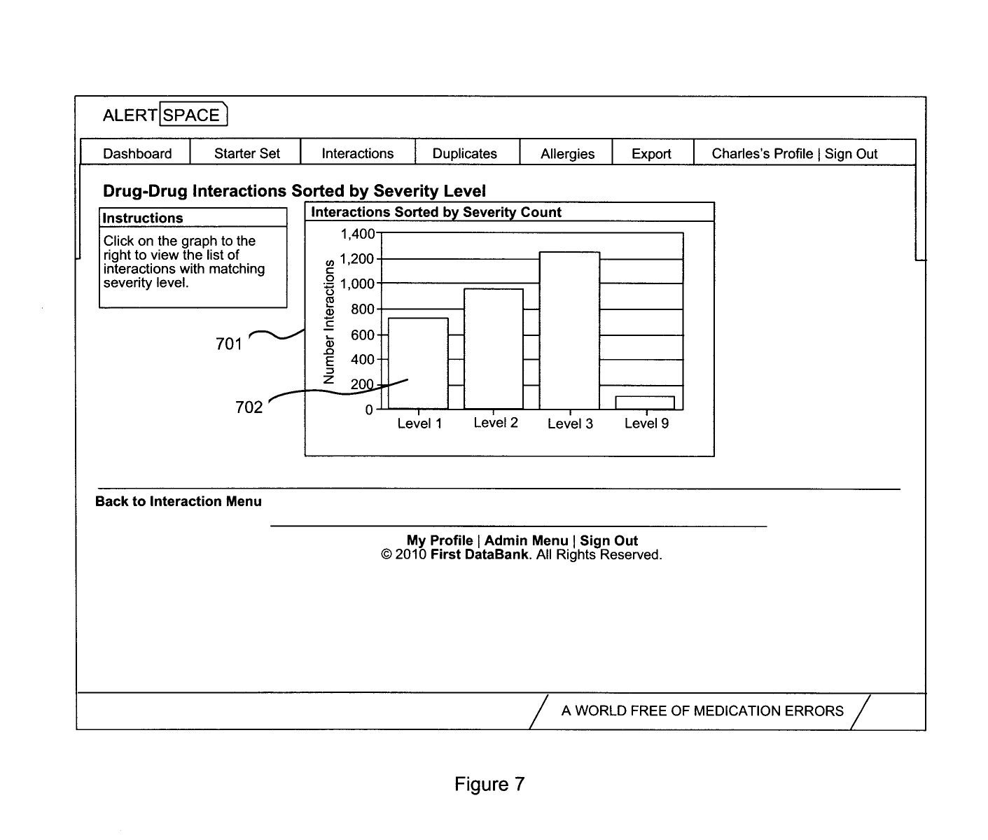

FIG. 7 illustrates an exemplary screen shot of alerts sorted by severity level, in accordance with exemplary embodiments. As depicted in FIG. 7, a user interacting with a user system 201 may be presented with a graphical depiction 701 of alert data. In various embodiments, the graphical depiction 701 may be interactive, such that an end user may view a list of interactions having a particular severity level by selecting the portion of the graphical depiction 701 displaying that severity level. For example, an end-user may select level 1 severity count 702 in order to be presented with a list of level 1 interactions. It should be appreciated that many types of data may be depicted in graphical format according to the preferences of a user interacting with user system 201. Alternatively, one or more users may upload data, such as override data, that may present a list of top-firing (or other alerts) for a particular operating environment.

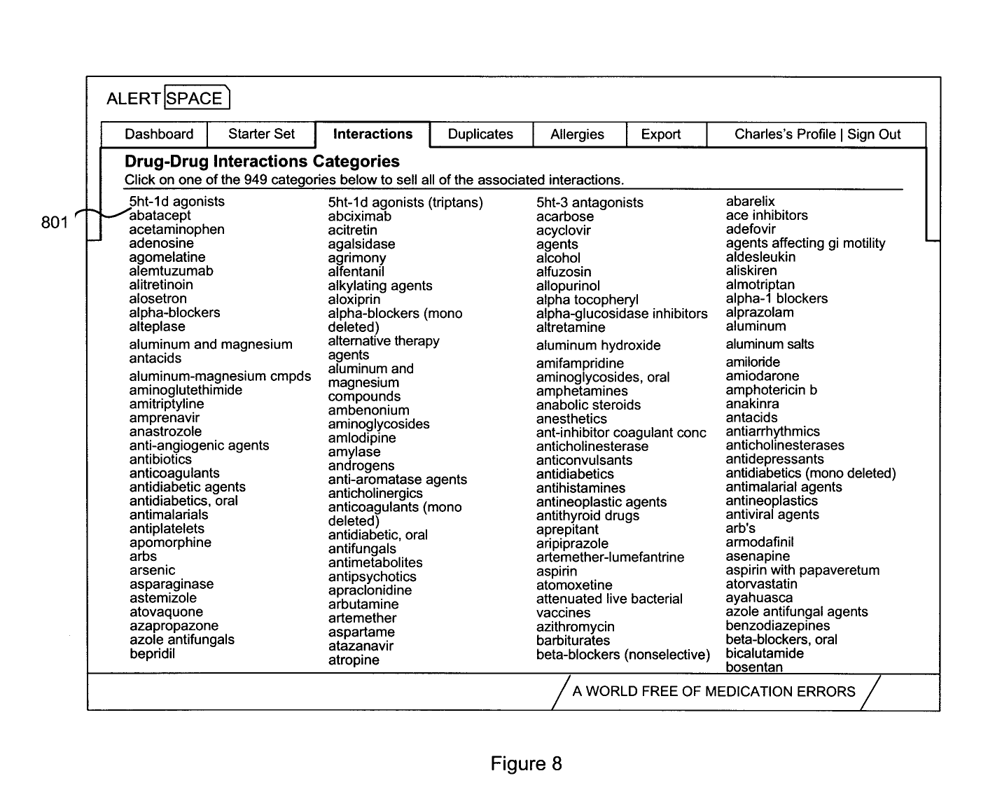

FIG. 8 illustrates an exemplary screen shot of exemplary drug-drug interaction categories, in accordance with exemplary embodiments. As illustrated in FIG. 8, the customized alert generation system 202 may output to a user interacting with a user system 201 a listing or one or more drug-drug interaction categories, such as drug-drug interaction category 801. In various embodiments, the user may navigate to one or more other electronic pages by activating a navigation virtual button or hyperlink associated with a particular drug-drug interaction category, such as drug-drug interaction category 801. By way of non-limiting example, the user may select a given drug-drug interaction to navigate to an electronic page presenting all interactions associated with the particular drug-drug interaction. In another exemplary embodiment, the list of drug interaction categories may be filtered, sorted, or searched upon receipt of a user input. Algorithms may also be utilized to present categories that are determined to be likely of interest to the user. Therefore, for example, an end-user with a tendency to more often modify the alert settings for generic drugs may be provided with generic drugs among its recommended items of interest. The algorithms may be modified in any number of ways to return results that are most likely of interest to the particular end-user.

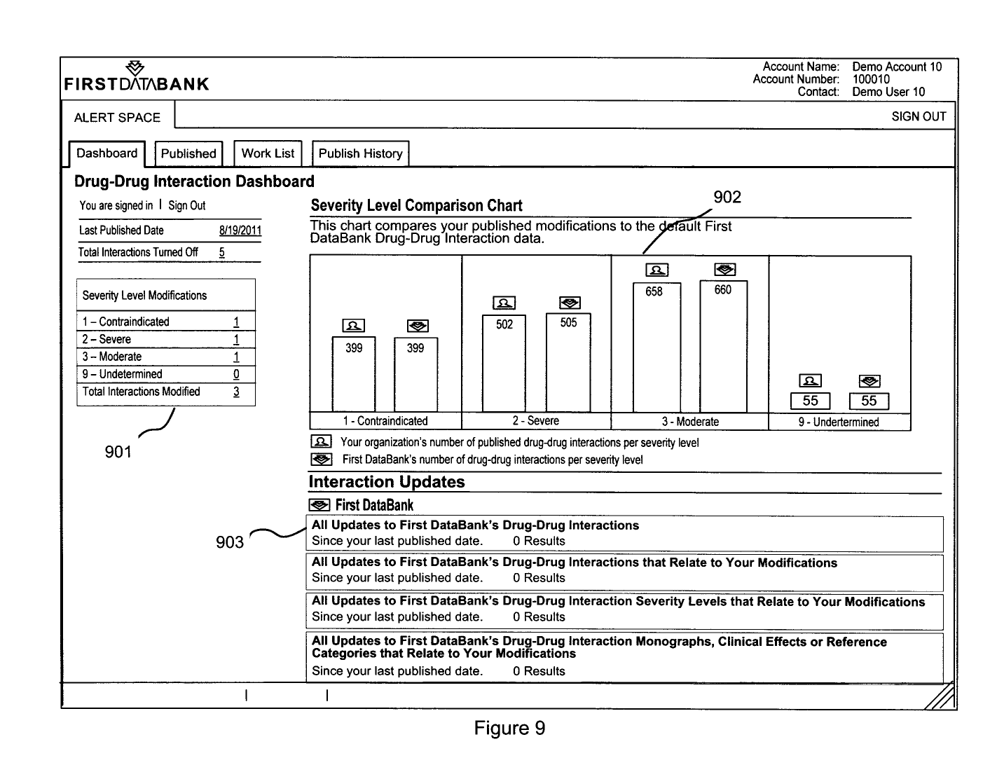

FIG. 9 illustrates an exemplary screen shot of a drug-drug interaction dashboard, in accordance with exemplary embodiments. As illustrated in FIG. 9, the customized alert generation system 202 may output to a user interacting with a user system 202 a dashboard demonstrating various statistics related to customized alert. In various exemplary embodiments, the user may presented with the number of severity level modifications made at window 901. Further, a severity level comparison chart 902 may provide a comparison of a user's customized alert modifications versus the original alerts provided in a starting database. Further, in other exemplary embodiments, the severity level comparison chart 902 may provide an indication of the number of published modification for the user versus the number of modifications as compared to other users. At window 903, the user may be provided with a number of interaction updates. Exemplary interaction updates may include a listing of all updated to a starting database drug-drug interactions, all updates to a starting databases drug-drug interactions that relate to a given user modification, all updates to a starting databases drug-drug interaction severity levels that relate to a user's modification, and/or all updates to a starting databases drug-drug interaction monographs, clinical effects, or reference categories that relate to a user's modifications. It should also be appreciated that, in various exemplary embodiments, portions of the screens presented to a user may be selectable, whereby a user may click on a portion of the screen and be presented with additional data or be routed to a different interactive screen.

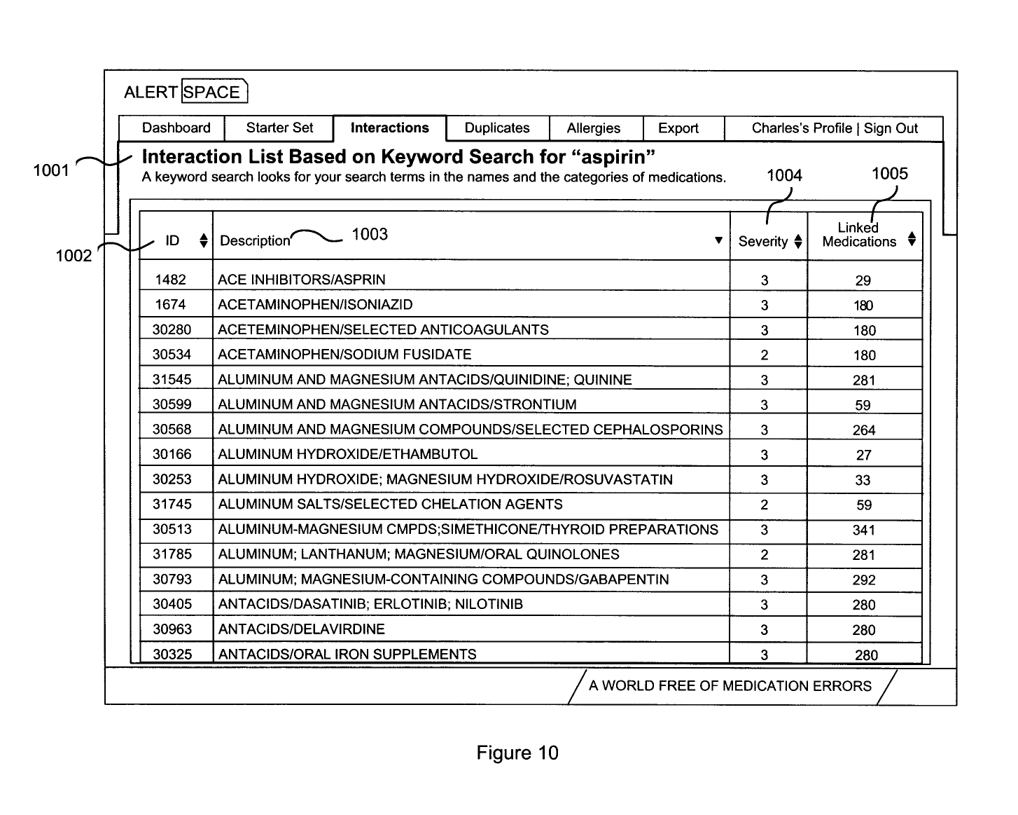

FIG. 10 illustrates an exemplary screen shot of a drug-drug interaction list based on keyword searches, in accordance with an exemplary embodiment. As illustrated in FIG. 10, the customized alert generation system 202 may output to a user interacting with a user system 201 a list 1001 of drug-drug interactions based on a search term (e.g., Aspirin). In various exemplary embodiments, the search results may display an interaction identification number 1002, a drug-drug interaction description 1003, a severity level 1004, and an indication of the number of linked medications 1005 associated with the particular drug-drug interaction. The severity level 1004 may display a severity level for a particular drug-drug interaction as determined by a starting database, or it may the current severity level as customized by the end-user. The linked medications 1005 field may provide a numerical indication of the number of medications that may be associate with the displayed drug-drug interaction. A user interacting with user system 201 may sort the results displayed in the interaction list 1001 according to, for example, identification number 1002, description 1002, severity level 1004, and/or linked medication 1005.

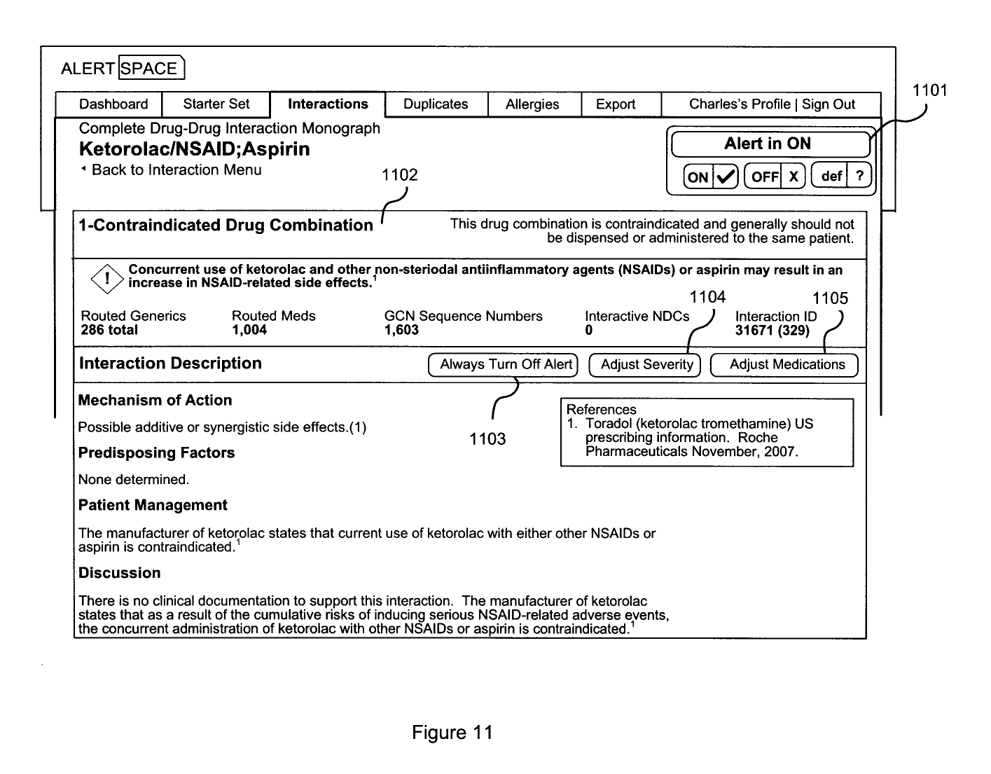

FIG. 11 illustrates an exemplary screen shot of a drug-drug interaction alert customization interface, in accordance with exemplary embodiments. As illustrated in FIG. 11, the customized alert generation system 202 may present a user interacting with a user system 201 multiple customization options related to a particular alert. In various embodiments, the user may be presented with an alert status display 1101 which indicates whether the selected alert is on, off, or default. Default may permit a user to reset a particular interaction, or group of interactions, back to the original interaction alert level. The user may also be presented with a threat score and narrative description of the significance of the particular interaction at, such as depicted at threat score display 1102. For example, a particular drug-drug interaction may be designated as “contraindicated,” which informs the healthcare provider that the drug combination should generally not be dispensed or administered to the same patient. In various embodiments, the end-user may be presented with the option to modify the alert at buttons 1103, 1104, and/or 1105. For instance, the end-user may have the option to always turn off an alert, adjust the severity of an alert, or adjust medications associated with the alert. It should be appreciated that other customization options may be presented at buttons 1103, 1104, and/or 1105. In additional exemplary embodiments, alerts may be customized based on target audience. For example, the alert may be customized such that it is displayed to certain healthcare providers and not others. For instance, an alert may be presented to nurses and not doctors, or it may be presented to certain healthcare providers based on their level of experience or ability level.

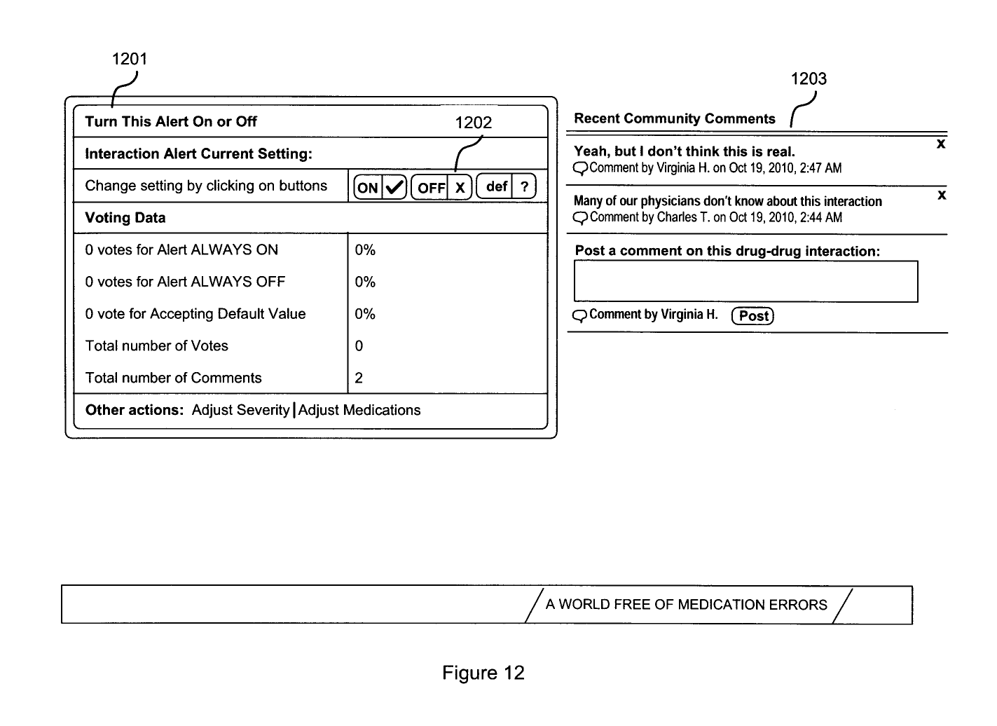

FIG. 12 illustrates an exemplary screen shot of a commenting interface, in accordance with exemplary embodiments. As shown in the exemplary embodiment depicted in FIG. 12, the customized alert generation system 202 may present a user interacting with user system 201 with voting data 1201 related to a particular alert. The customized alert generation system 202 may compile the voting data it receives from the various user systems (e.g., 201A-201N) to process the various results of the voting data 1201. The user may be presented with alert modification options 1202, which permit an end-user interacting with user system 201 to modify the alert setting for that particular alert. It should be appreciated that voting data may be obtained from user systems automatically whenever alerts are modified. In other exemplary embodiments, the voting data may be obtained from those users interacting with user systems 201A-201N that submit a vote for a particular alert. In exemplary embodiments, a comments interface 1203 may be provided, which permits users interacting with user-systems 201A-20N to submit comments regarding a particular alert or read community comments relating to the alert. It may be beneficial to provide the comments feature to capture controversy or consensus among various users related to a given alert.

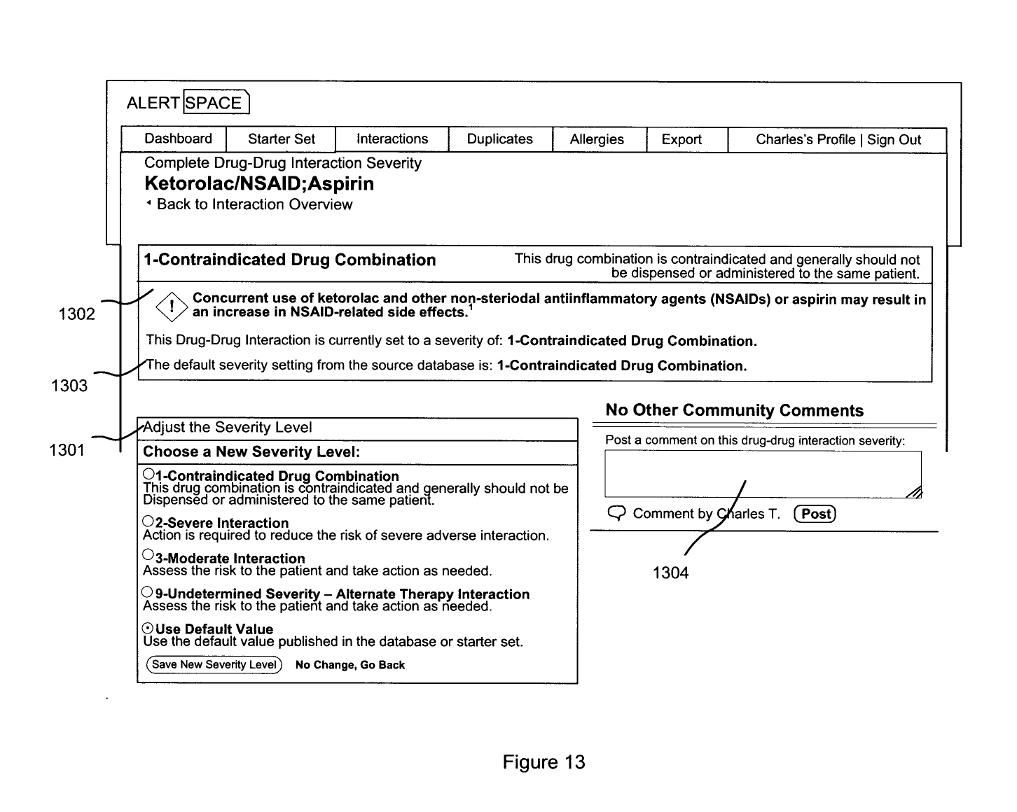

FIG. 13 illustrates an exemplary screen shot of a drug-drug interaction customization interface, in accordance with exemplary embodiments. As depicted in FIG. 13, a user interacting with user system 201 may be presented with a customization interface 1301 for customizing the alert severity level for a given alert. Further, the user may be presented with an indication of the current setting 1302 of the alert severity level and the default setting 1303 of the alert severity level. The user may be enter a new severity level (e.g., contraindicated drug combination, severe interaction, moderate interaction, alternative therapy interaction, etc.) within the customization interface 1301. When a new severity level is chosen, the user system 201 will record the change and modify the customized drug-drug interaction database accordingly. The user may also be presented with a comment interface 1304, which allows the user to post a comment related to that particular drug-drug interaction severity level to the broader user community.

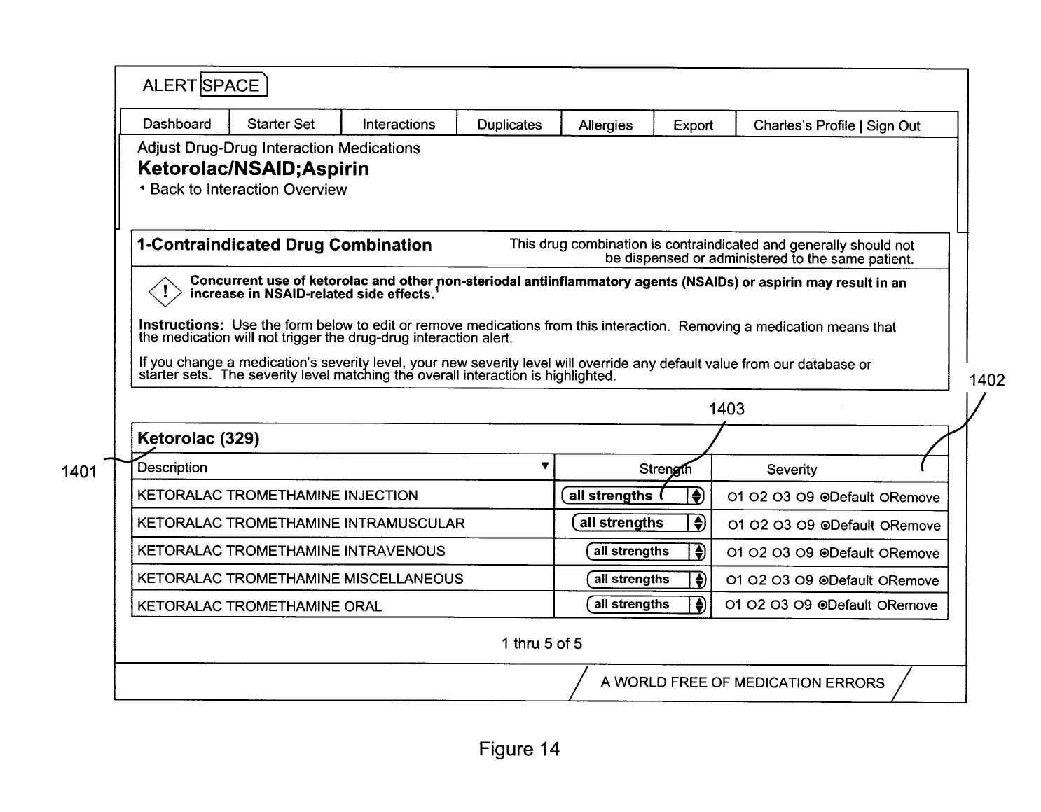

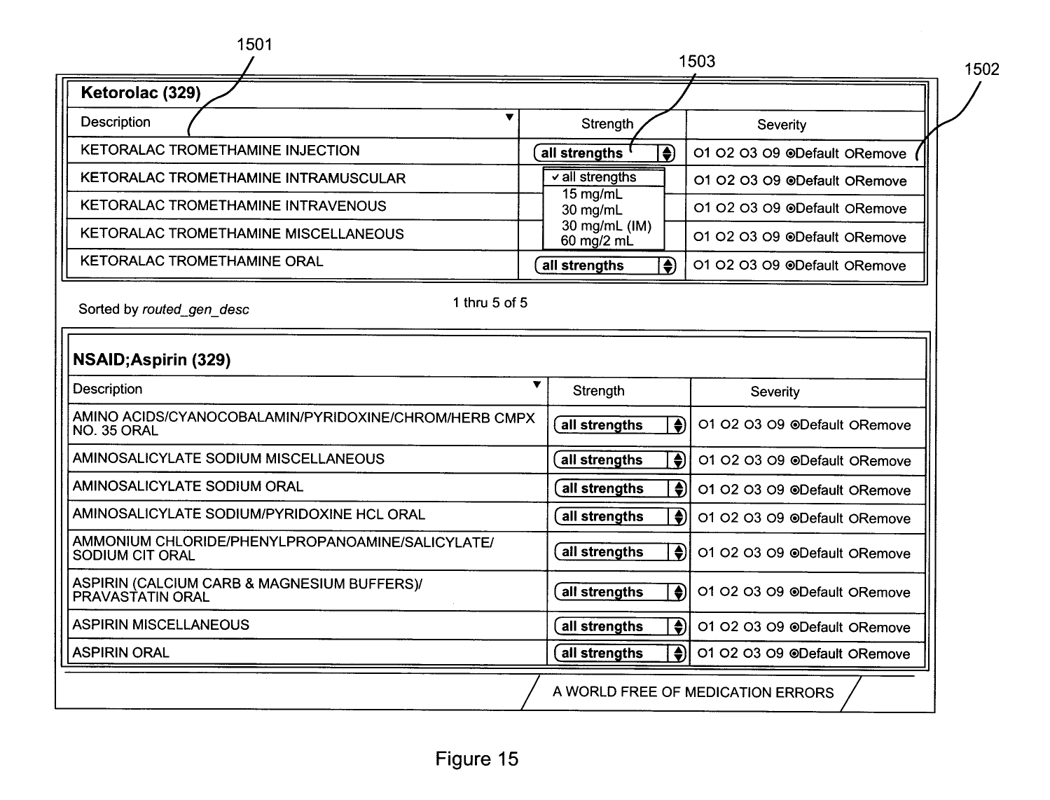

FIGS. 14 and 15 illustrate exemplary screenshots of an additional drug-drug interaction customization interface, in accordance with exemplary embodiments. As shown in FIGS. 14 and 15, a user interacting with user system 201 may be presented with a customization interface 1401 and/or 1501 for further modifying alert settings. In various exemplary embodiments, the user may choose a severity level 1402 and/or 1502 related to a given strength 1403 and/or 1503. For a given drug, further customization may be provided depending upon the treatment method. By way of a non-limiting example, the user may provide a higher threshold to trigger an alert for an injection of a particular drug-drug interaction, while completely deactivating the alert for that drug-drug interaction when administered orally. In various exemplary embodiments, a particular alert may be automatically removed from the database based on pre-set conditions. By way of non-limiting example, a drug interaction alert may be removed based on drug dose strength, drug dose form, and/or drug dose route.

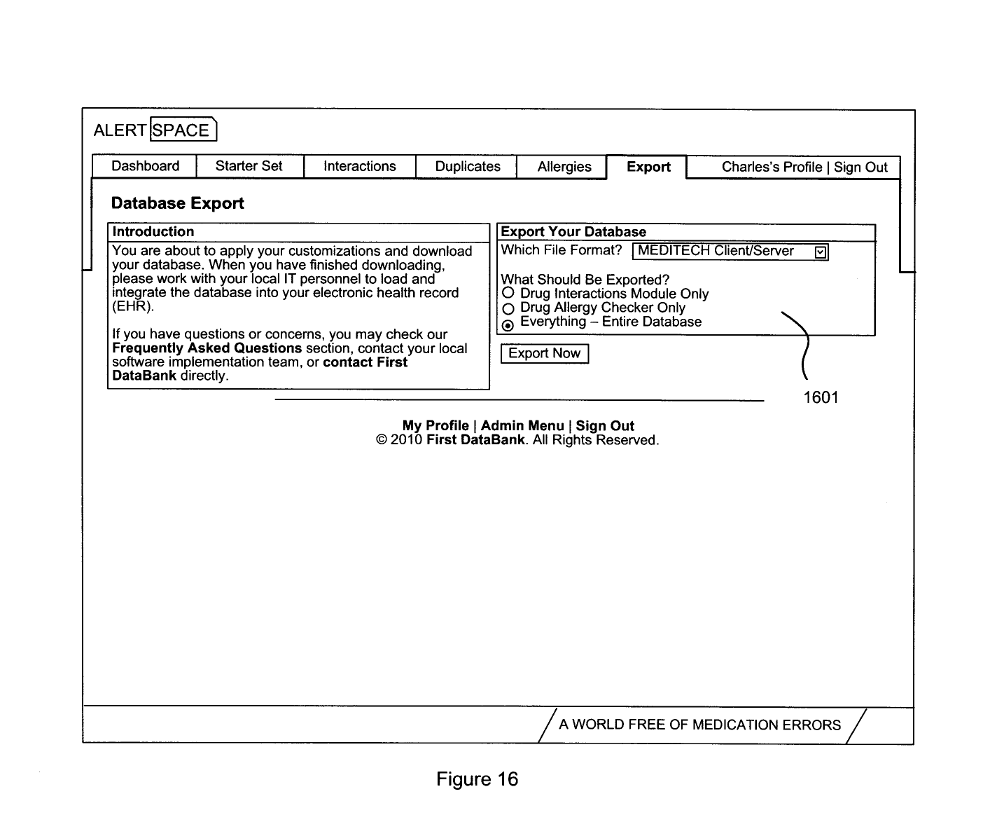

FIG. 16 illustrates an exemplary screenshot of a database export interface, in accordance with exemplary embodiments. As shown in FIG. 16, a user interacting with the user system 201 may be prompted to apply alert customizations and to download the customized database to a local storage or network. A database export interface 1601 may be provided to select a format for exporting the customized database. By way of a non-limiting example, the user may choose a particular file format (e.g., Microsoft Excel, CSV, PDF, raw text, etc.) and/or the particular customized alert database to be downloaded (e.g., drug-drug interaction, drug-allergy, etc.). It should be appreciated that the various customization options and user inputs may be saved or stored in one or more of the various components of the system. In various embodiments, alert settings may be stored in the customized alert generation system 202 and/or the user system 20, the drug database system 203, and/or the data network 204. It should be appreciated that, in various exemplary embodiments, the database may be automatically published. For example, a user may click save (or the program may auto-save) and the changes made to particular alert settings may automatically be published.

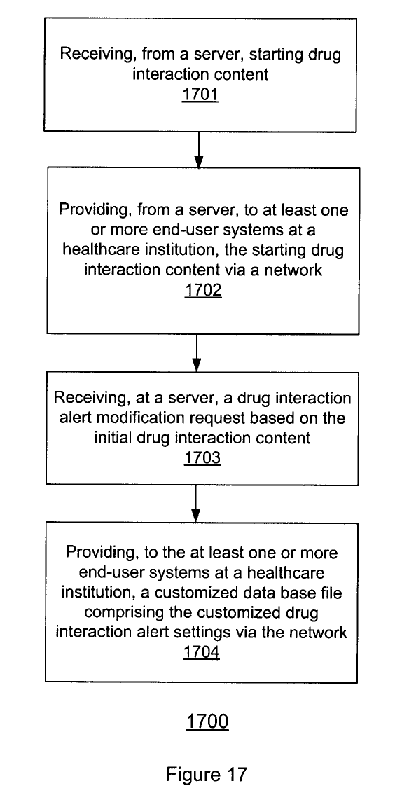

FIG. 17 illustrates a flowchart of a method of generating one or more customized drug interaction alert settings associated with a health care institution, in accordance with exemplary embodiments. This exemplary method is provided by way of example. The method 1700 shown in FIG. 17 can be executed or otherwise performed by one or more combinations of various systems. The method 1700 is described below as carried out by the system for providing customized alert settings 201 as shown in FIG. 2 by way of example, and various elements of the system for providing customized alert settings are referenced in explaining the method of FIG. 17. Each block shown in FIG. 17 represents one or more processes, methods, or subroutines carries in the exemplary method 1700. Referring to FIG. 17, the exemplary method 1700 may begin at block 1701.

In block 1701, the method 1700 may include receiving, from a server, starting drug interaction content. In an exemplary embodiment, the data source interface module 216 may receive starting drug interaction content from a drug database system 203 via data network 204. The method 1700 may continue to block 1702.

In block 1702, the method 1700 may include providing, from a server, to at least one or more end-user systems at a healthcare institution, the starting drug interaction content via a network. In an exemplary embodiment, the data source interface module 216 may provide starting drug interaction content to a user system 201 via the network 204. The method may continue to block 1703.

In block 1703, the method 1700 may include receiving, at a server, a drug interaction alert modification request based on the initial drug interaction content. In an exemplary embodiment, the web server module 214 may receive the request over network 204 from user system 201. The method 1700 may continue to block 1704.

In block 1704, the method 1700 may include providing, to the at least one or more end-user systems at a healthcare institution, a customized data base file comprising the customized drug interaction alert settings via the network. In an exemplary embodiment, the customized alert generation module 218 may generate one or more customized drug interaction alert settings. The customized alert settings may be transmitted to user system 201 over data network 204. The method 1700 may then end.

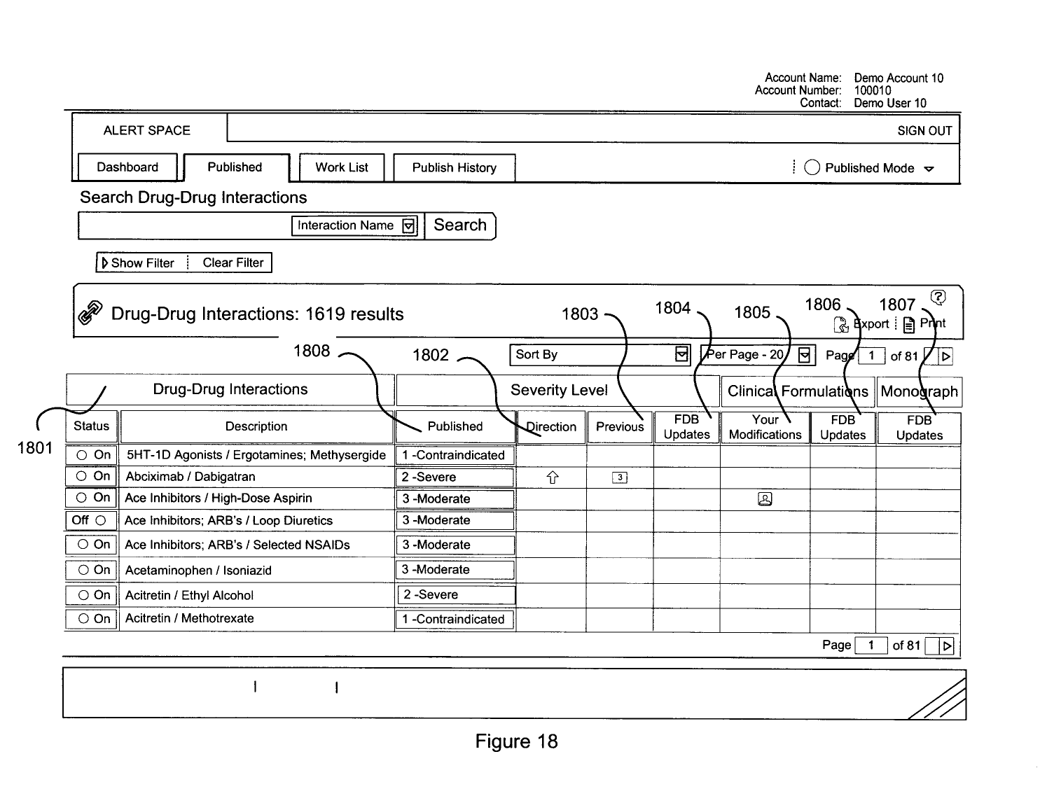

FIG. 18 illustrates an exemplary screen shot of an alert display screen, in accordance with exemplary embodiments. As depicted in FIG. 18, a user interacting with user system 201 may be presented with a display screen that lists a number of drug-drug interaction alerts 1801. The display screen may demonstrate to the user the published alert level 1808 for a given drug-drug interaction alert. Moreover, the user may be presented with additional information, including the direction 1802 of the alert severity level (e.g., more-severe v. less-severe as modified), an indication of the previous 1803 alert level, FDB 1804 updates (e.g., First DataBank updates), and a listing of the modification made by the user at 1804.

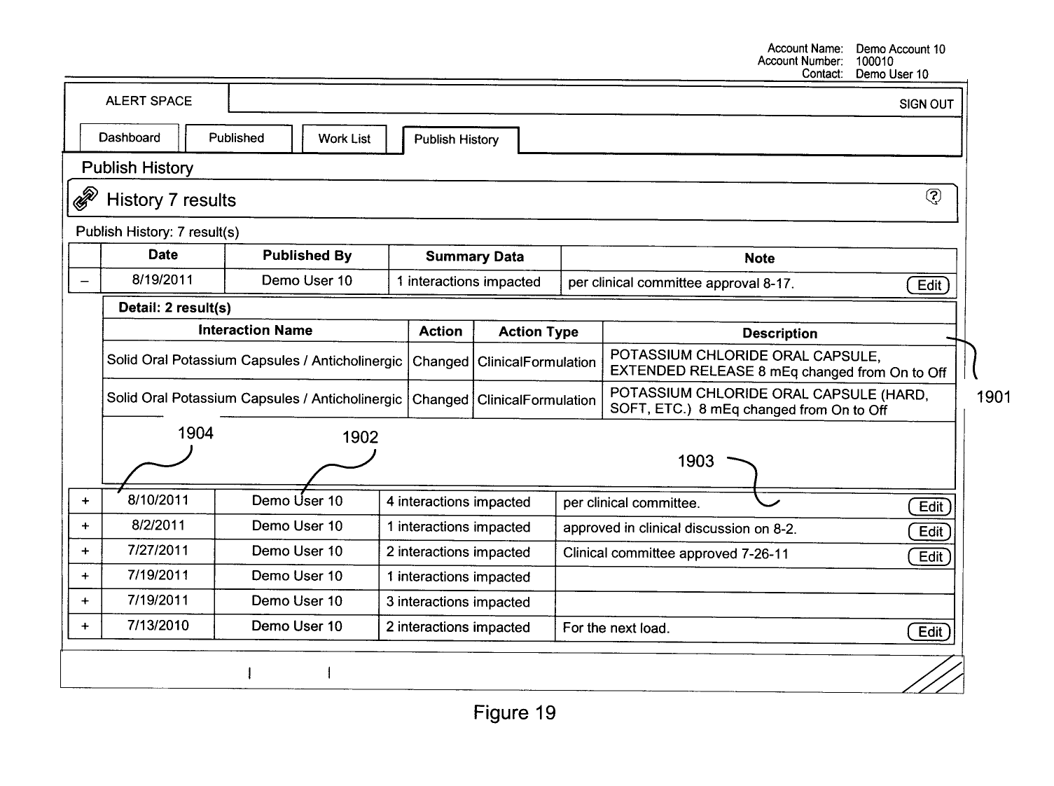

FIG. 19 illustrates an exemplary screen shot of an audit trail screen, in accordance with exemplary embodiments. As depicted in FIG. 19, a user interacting with user system 201 may be presented with an audit trail screen that provides an indication of the changes that have been made to particular alerts. The audit screen may display a description 1901 of the changes to the alert, the user 1902 that changed the alert, an indication 1903 of the reasons for the changed alert and/or the date 1904 that the alert was changed. In various exemplary embodiments, the audit trail may be sortable by date, number of interactions impacted, or by the name of the person that changed the alert. It should be appreciated that a user interacting with user system 201 may also edit alerts from the audit trail screen.

The previous description is intended to convey an understanding of the embodiments described by providing a number of exemplary embodiments and details involving systems and methods for providing customized alert settings. It should be appreciated, however, that the present invention is not limited to these specific exemplary embodiments and details. It is further understood that one possessing ordinary skill in the art, in light of known systems and methods, would appreciate the use of the invention for its intended purposes and benefits in any number of alternative embodiments, depending on specific design and other needs.

The description above describes elements of a network that may include one or more modules, some of which are explicitly shown in the figures, others that are not. As used herein, the term “module” may be understood to refer to computing software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

The description above also describes physical and logical elements of a network and/or a system, some of which are explicitly shown in figures, others that are not. The inclusion of some physical elements of a network and/or a system may help illustrate how a given network and/or system may be modeled. It should be noted, however, that all illustrations are purely exemplary and that the network and/or system scheme described herein may be performed on different varieties of networks and/or systems which may include different physical and logical elements.

It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof.

Although this invention has been described with reference to particular embodiments, it will be appreciated that many variations may be resorted to without departing from the spirit and scope of this invention. For example, while the present invention has been described in connection with providing customized alert settings related to drug-drug interactions in a healthcare provider setting, it is not limited thereto and may include any other alert settings (e.g., dose alert, drug-allergy, etc.) or be deployed in other operational settings involving alerts (e.g., accounting systems, information technology systems, etc.). Also, the system of the present invention may be implemented over a local network or a virtual private network or any internet networked system, and is not limited to the internet.

1. A system for providing customized drug interaction alert settings to one or more end-user systems at a health care institution, the system comprising:
a programmed processor configured to provide, to at least one or more end-user systems at a health care institution, a starting drug interaction content via a network;
a programmed processor configured to receive, from the at least one of the one or more end-user systems, one or more drug interaction alert customization requests based on the initial drug interaction content via the network; and
a programmed processor configured to provide, to the at least one of the one or more end-user systems, a customized database file comprising the customized drug interaction alert settings via the network;
wherein the customized drug interaction alert settings are automatically implemented in a prescribing software executing on the one or more end-user systems.

2. The system of claim 1, further comprising:
a programmed processor configured to aggregate drug interaction alert customization requests from two or more end-user systems at a health care institution; and
a programmed processor configured to provide, to the at least one of the one or more end-user systems, information related to the aggregated drug interaction alert customization requests via the network.

3. The system of claim 1, further comprising:
a programmed processor configured to receive drug interaction medical research; and
a programmed processor configured to provide medical research prompts to the one or more end-user systems.

4. The system of claim 1, wherein the drug interaction alert customization request comprises removing a drug that triggers a drug interaction alert.

5. The system of claim 4, wherein the drug is removed automatically based on drug dose strength, drug dose form, or drug dose route.

6. The system of claim 1, wherein the customized drug interaction alert settings are displayed on a mobile device.

7. The system of claim 1, wherein the drug interaction alert customization requests comprise changing the severity level.

8. The system of claim 1, wherein the drug interaction alert customization requests comprise turning off a drug interaction alert.

9. The system of claim 1, wherein the drug interaction alert customization requests comprise turning on a drug interaction alert.

10. The system of claim 3, wherein the drug interaction alert customization requests are automatically provided based on the medical research prompts.

11. The system of claim 2, wherein the drug interaction alert customization requests are automatically provided based on the information related to the aggregated drug interaction alert customization requests.

12. The system of claim 1, further comprising a programmed processor configured to present the user with alerts recommended to be modified.

13. The system of claim 12, wherein the alerts recommended to be modified are those that are most fired, most overridden, or most ignored.

14. A method of generating one or more customized drug interaction alert settings associated with a health care institution, the method comprising:
providing, from a server, to at least one or more end-user systems at a healthcare institution, the starting drug interaction content via a network;
receiving, at a server, a drug interaction alert customization request based on the initial drug interaction content;
providing, to the at least one or more end-user systems at a healthcare institution, a customized data base file comprising the customized drug interaction alert settings via the network; and
wherein the customized drug interaction alert settings are automatically implemented in a prescribing software executing on the one or more end-user systems.

15. The method of claim 14, wherein the drug interaction alert customization request comprises turning a drug interaction alert off.

16. The method of claim 14, wherein the drug interaction alert customization request comprises changing a severity level of a drug interaction alert.

17. The method of claim 14, wherein the drug interaction alert customization request comprises removing a drug that triggers a drug interaction alert.

18. The method of claim 17, wherein the drug is removed automatically based on drug dose strength, drug dose form, or drug dose route.

19. The method of claim 14, further comprising:
receiving, from a server, healthcare research related to one or more alerts.

20. The method of claim 14, wherein the customized drug interaction alert settings are visually displayed on a mobile device.

21. A method of eliminating one or more drug interaction alerts on an end-user system of a health care institution, the method comprising:
receiving, on the end-user system, one or more customized drug interaction alert settings;
receiving, from a user, an order for a new drug associated with a patient;
comparing, on the end-user system, the order for the new drug to a plurality of drugs associated with the patient; and
initiating, on the end-user system, one or more drug interaction alerts based on the comparison and the one or more customized drug interaction alert settings.

22. The method of claim 21, further comprising:
receiving, on the end-user system, one or more drug interaction alert customization reports related to one or more third-party end-user systems;
determining, on the end-user system, a common customization preference based on data obtained from the one or more drug interaction alert customization report.
